(19) United States
(12) Patent Application Publication
(10) Pub. No.: US 2014/0083455 A1
(43) Pub. Date: Mar. 27, 2014

(54) Wiper Cleaning Assembly

(71) Applicant: Abdulkadir Ali, Columbus, OH (US)

(72) Inventor: Abdulkadir Ali, Columbus, OH (US)

(21) Appl. No.: 13/624,240

(22) Filed: Sep. 21, 2012

(51) Int. Cl. B08B 1/00; B60S 1/62; B60S 3/00

(52) U.S. Cl. 134/6; 15/246; 15/256.5

(57) ABSTRACT

A wiper cleaning assembly for cleaning and removing residue from a moving wiper. The wiper cleaner includes a stationary planar pad, securely joined with a wiper surface, which engages and cleans a moving wiper as the wiper passes through the wiper cleaner. In this manner, the wiper cleaner cleans the wiper with minimal moving parts, and without having to be handled. The wiper cleaner includes a cleaning surface with an abrasive portion for physically engaging a moving wiper. The abrasive portion includes rubber bristles and ridges for enhancing the cleaning function. A thermal portion positions behind the abrasive portion to provide heat to the wiper cleaner. The heat is efficacious for removing ice from the wipers as the pass by. A mounting portion includes an adhesive that secures the wiper cleaner to the windshield. The wiper cleaner detaches and secures to various areas of the windshield.

### CROSS-REFERENCE TO RELATED APPLICATIONS

The present Utility patent application claims priority benefit of the [U.S. provisional application for patent Ser. No. 61/538,781 entitled “Windshield Wiper Cleaner”, filed on Sep. 23, 2011, under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to wiper blades. More particularly, one or more embodiments of the invention relate to cleaning wiper blades.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a windshield wiper is a device used to remove rain and debris from a windscreen or windshield. Almost all motor vehicles, including trains, aircraft and watercraft, are equipped with such wipers, which are usually a legal requirement.

Typically, the windshield wiper consists of an arm, pivoting at one end and with a long rubber blade attached to the other. The blade is swung back and forth over the glass, pushing water from its surface. Ice and debris often accumulates on the windshield wiper.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a detailed perspective view of an exemplary wiper cleaner positioned on an exemplary wiper surface, in accordance with an embodiment of the present invention;

FIG. 2 illustrates a detailed perspective view of an exemplary cleaning surface for an exemplary wiper cleaner, in accordance with an embodiment of the present invention;

FIG. 3 illustrates a detailed perspective view of an exemplary mounting surface with an exemplary adhesive portion, in accordance with an embodiment of the present invention;

FIG. 4 illustrates a detailed perspective view of an exemplary cleaning surface having an exemplary at least one ridge and an exemplary thermal portion, in accordance with an embodiment of the present invention; and

FIG. 5 illustrates a detailed perspective view of an exemplary mounting surface with an exemplary thermal portion, in accordance with an embodiment of the present invention.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

The present invention will now be described in detail with reference to embodiments thereof as illustrated in the accompanying drawings.

There are various types of wiper cleaners that may be provided by preferred embodiments of the present invention. In one embodiment of the present invention, the wiper cleaner may provide an assembly that engages a wiper for cleaning and removing at least one residue from the wiper. In some embodiments, the wiper cleaner may include a stationary planar pad, securely joined with a wiper surface, which engages and cleans a moving wiper as the wiper passes through the wiper cleaner. In this manner, the wiper cleaner may clean the wiper with minimal moving parts, and without having to be handled.

In one embodiment of the present invention, the wiper cleaner may include a flat, planar pad that is configured to engage the wiper, yet also allow the wipe to pass through the wiper cleaner freely. The pad may be configured to provide a surface area sufficiently sized and dimensioned to clean the wiper. In one embodiment, the wiper cleaner may include two surfaces that press against each other, yet perform different functions. A cleaning surface may serve to engage the wiper as the wiper passes through the wiper cleaner. In some embodiments, the cleaning surface may include a convex surface. The convex surface may be configured to provide a compressive force against a tip of the wiper. In one embodiment, the cleaning surface may include an abrasive portion for forcibly engaging the wiper. The abrasive portion may include at least one rubber bristle. Those skilled in the art, in light of the present teachings will recognize that the rubber bristles may provide sufficient rigidity to knock the residue from the wiper. However, the rubber bristles may also have sufficient flexibility to allow the wiper to pass through freely. Suitable materials for the abrasive portion may include, without limitation, rubber, metal bristles, plastic, polyvinyl chloride, high density polyurethane, wool, magnets, and silicone.

In one embodiment of the present invention, a mounting surface may press against an opposite side of the cleaning surface to form the wiper cleaner. The mounting surface may include an adhesive portion for securely joining the wiper cleaner with the wiper surface. The adhesive portion may include a removable strip that overlays an adhesive, including, without limitation, glue, paste, cement, tape, hooks, and magnets. The adhesive portion may allow the wiper cleaner to remain stationary while the wiper passes through the cleaning surface from a plurality of areas on the wiper cleaner.

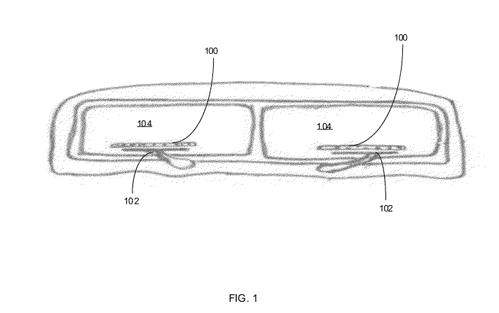

FIG. 1 illustrates a detailed perspective view of an exemplary wiper cleaner 100 positioned on an exemplary wiper surface, in accordance with an embodiment of the present invention. In the present embodiment, the wiper cleaner may provide an assembly that engages a wiper 102 for cleaning and removing at least one residue from the wiper. The wiper may include, without limitation, a windshield wiper, a window wiper, and a blade. In one embodiment, the wiper may oscillate from extreme ends of a wiper surface 104, including, without limitation, a windshield. The wiper may engage through two ends of the wiper cleaner on each pass. In some embodiments, the wiper cleaner may include a stationary planar pad, securely joined with a wiper surface, which engages and cleans a moving wiper as the wiper passes through the wiper cleaner. In this manner, the wiper cleaner may clean the wiper with minimal moving parts, and without having to be handled. In some embodiments, the wiper cleaner may position on a lower area of a windshield for maximizing contact with the wiper, and also not hindering the view of a vehicle operator. However, in other embodiments, the wiper cleaner may be detachably moved to various areas of the wind shield as needed.

In one embodiment of the present invention, the wiper cleaner may include a flat, planar pad that is configured to engage the wiper, yet also allow the wipe to pass through the wiper cleaner freely. Those skilled in the art, in light of the present teachings will recognize that the planar configuration of the wiper cleaner may allow the wiper to engage the wiper cleaner freely with minimal obstruction. However, in other embodiments, the wiper cleaner may be configured into various shapes, including, without limitation, a square, a circle, and a triangle. The pad may be configured to provide a surface area sufficiently sized and dimensioned to clean the wiper. Suitable materials for fabricating the wiper cleaner may include, without limitation, rubber, plastic, silicone, absorbent cloth, wood, pulp, polyvinyl chloride, high density polyurethane, and metal. In one embodiment, the wiper cleaner may include two surfaces that press against each other, yet perform different functions.

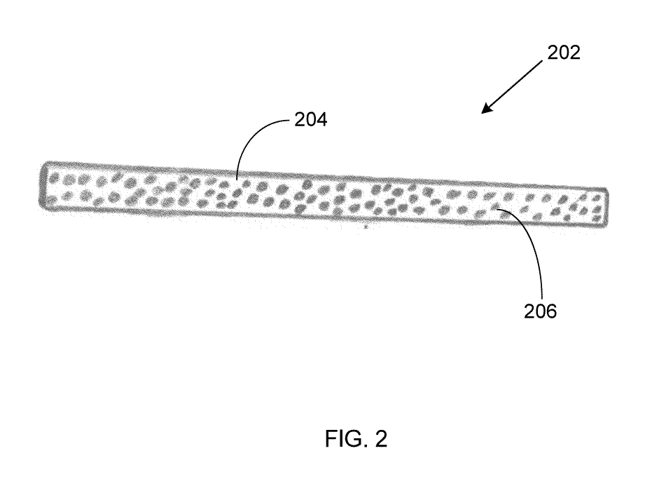

FIG. 2 illustrates a detailed perspective view of an exemplary cleaning surface for an exemplary wiper cleaner, in accordance with an embodiment of the present invention. In the present embodiment, the wiper cleaner may include two surfaces that press against each other, yet perform different functions. A cleaning surface 202 may serve to engage the wiper as the wiper passes through the wiper cleaner. In some embodiments, the cleaning surface may include a convex surface. The convex surface may be configured to provide a compressive force against a tip of the wiper. However, the cleaning surface may include a flat surface or a concave surface, depending on the type and size of the wiper. In one embodiment, the cleaning surface may include an abrasive portion 204 for physically removing the residue from the wiper. The abrasive portion may include at least one rubber bristle 206. Those skilled in the art, in light of the present teachings will recognize that the rubber bristles may provide sufficient rigidity to knock the residue from the wiper. However, the rubber bristles may also have sufficient flexibility to allow the wiper to pass through freely. Suitable materials for the abrasive portion may include, without limitation, rubber, metal bristles, plastic, polyvinyl chloride, high density polyurethane, wool, magnets, and silicone.

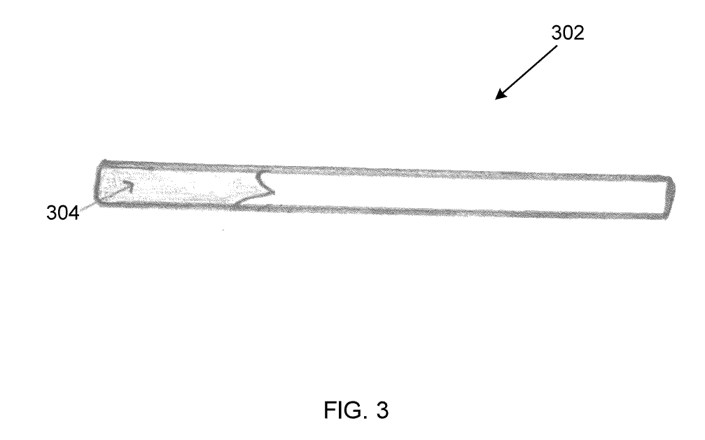

FIG. 3 illustrates a detailed perspective view of an exemplary mounting surface with an exemplary adhesive portion, in accordance with an embodiment of the present invention. In the present embodiment, a mounting surface 302 may press against an opposite side of the cleaning surface to form the wiper cleaner. The mounting surface may include an adhesive portion 304 for securely joining the wiper cleaner with the wiper surface. The adhesive portion may include a removable strip that overlays an adhesive, including, without limitation, glue, paste, cement, tape, hooks, and magnets. The adhesive portion may allow the wiper cleaner to remain stationary while the wiper passes through the cleaning surface from a plurality of areas on the wiper cleaner. In one alternative embodiment, the adhesive portion positions on two extreme ends of the mounting portion.

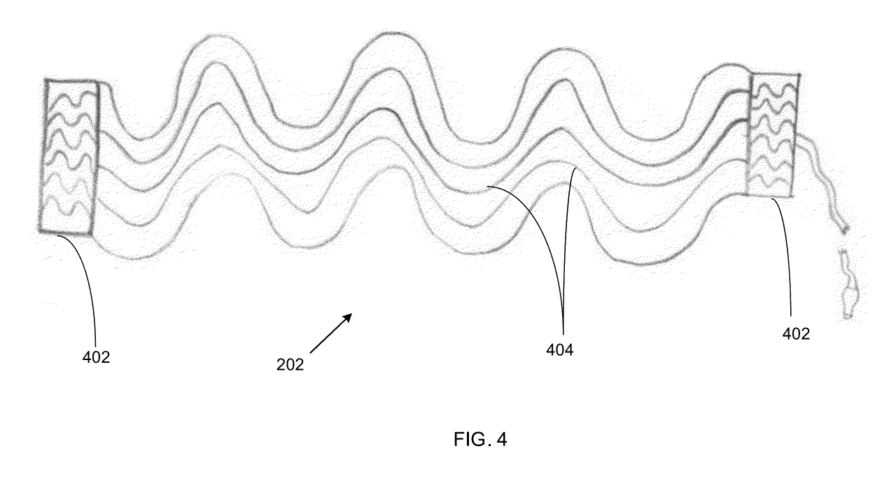

FIG. 4 illustrates a detailed perspective view of an exemplary cleaning surface having an exemplary at least one ridge and an exemplary thermal portion, in accordance with an embodiment of the present invention. In the present embodiment, the cleaning surface may include an abrasive portion with at least one ridge 404. Each ridge may provide an increase in surface area efficacious for engaging a maximum area of the wiper. In some embodiments, each ridge may include a channel for storing the at least one residue, wherein the ridges may funnel residue into the channel from a plurality of directions.

In one embodiment of the present invention, the abrasive portion may include a thermal portion 402 for heating the wiper cleaner. As the wiper engages the rubber bristles of the abrasive portion, heat may transfer from the cleaning surface to the wiper. Those skilled in the art, in light of the present teachings will recognize that the thermal portion may serve to melt ice and freezing rain from the wiper. The thermal portion may generate heat through various means, including, without limitation, electrical heat, de-icer, and infrared wavelengths. A power source may provide energy to the thermal portion. In one alternative embodiment, the abrasive portion may release a composition for polishing windows or melting ice. As the wiper passes through the cleaning surface, the composition joins with the wiper and is distributed across the wiper surface.

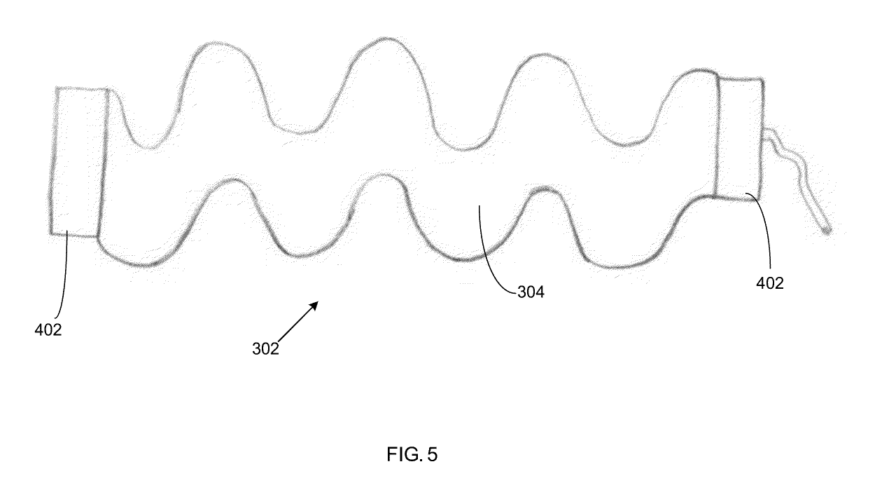

FIG. 5 illustrates a detailed perspective view of an exemplary mounting surface with an exemplary thermal portion, in accordance with an embodiment of the present invention. In the present embodiment, the thermal portion may position between the adhesive portion and the mounting surface. The mounting surface may include a peelable membrane that overlays the mounting surface. In this manner, the adhesive portion may be utilized only when needed.

In one embodiment of the present invention, the wiper cleaner may include two pieces, each measuring 2″ height and 25″ length for a front windshield, and one piece 2″ height and 15″ length for a rear wiper. However, in another embodiment, the wiper cleaner may include one piece of 2″ height and 60″ length for the front windshield, and one 2″ height and 18″ length for the rear wiper. In one alternative embodiment, the wiper cleaner may be shaped and configured into a desired shape and dimension by cutting with scissors. Those skilled in the art, in light of the present teachings will recognize that tailoring the wiper cleaner at least ½″ longer than the wiper on both sides may provide extra cleaning area on the both ends of the wiper.

All the features or embodiment components disclosed in this specification, including any accompanying abstract and drawings, unless expressly stated otherwise, may be replaced by alternative features or components serving the same, equivalent or similar purpose as known by those skilled in the art to achieve the same, equivalent, suitable, or similar results by such alternative feature(s) or component(s) providing a similar function by virtue of their having known suitable properties for the intended purpose. Thus, unless expressly stated otherwise, each feature disclosed is one example only of a generic series of equivalent, or suitable, or similar features known or knowable to those skilled in the art without requiring undue experimentation.

Having fully described at least one embodiment of the present invention, other equivalent or alternative methods of implementing a stationary wiper cleaner that cleans a moving wiper according to the present invention will be apparent to those skilled in the art. Various aspects of the invention have been described above by way of illustration, and the specific embodiments disclosed are not intended to limit the invention to the particular forms disclosed. The particular implementation of the stationary wiper cleaner that cleans a moving wiper may vary depending upon the particular context or application. By way of example, and not limitation, the stationary wiper cleaner that cleans a moving wiper described in the foregoing were principally directed to cleaning windshield wiper blade implementations; however, similar techniques may instead be applied to skyscraper window cleaning assemblies, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A wiper cleaner comprising:
a cleaning surface, said cleaning surface being configured to engage a wiper, said cleaning surface comprising an abrasive portion, said abrasive portion being configured to remove at least one residue from said wiper; and
a mounting surface, said mounting surface being configured to join said wiper cleaner with a wiper surface, said mounting surface further being configured to secure said wiper cleaner to a predetermined and stationary position.

2. The wiper cleaner of claim 1, wherein said wiper cleaner is configured to be planar.

3. The wiper cleaner of claim 2, in which said wiper cleaner comprises a rectangular pad.

4. The wiper cleaner of claim 3, wherein said wiper cleaner securely presses against said wiper surface.

5. The wiper cleaner of claim 4, wherein said wiper cleaner is operable to remain stationary as said wiper moves past said wiper cleaner from a plurality of positions.

6. The wiper cleaner of claim 5, in which said wiper surface comprises a windshield.

7. The wiper cleaner of claim 6, wherein said cleaning surface is configured to clean said wiper.

8. The wiper cleaner of claim 7, in which said cleaning surface comprises a convex surface, said convex surface being operable to provide a compressive force against a tip of said wiper.

9. The wiper cleaner of claim 8, in which said abrasive portion comprises at least one rubber bristle, said at least one bristle being configured to remove said at least one residue from said wiper.

10. The wiper cleaner of claim 9, in which said abrasive portion comprises at least one ridge, said at least one ridge being configured to receive said at least one residue from said wiper.

11. The wiper cleaner of claim 10, wherein said abrasive portion is configured to be interchangeable.

12. The wiper cleaner of claim 11, in which said abrasive portion comprises a thermal portion, said thermal portion being operable to heat said wiper.

13. The wiper cleaner of claim 12, in which said mounting surface comprises an adhesive portion, said adhesive portion being configured to secure said wiper cleaner with said wiper surface.

14. The wiper cleaner of claim 13, wherein said wiper cleaner positions on a front wiper surface and a rear wiper surface of a vehicle.

15. A method of cleaning a wiper comprising:
means for orienting a wiper cleaner on a wiper surface so that a wiper engages said wiper cleaner;
means for securely joining a mounting surface with said wiper surface;
means for moving said wiper; and
means for cleaning said wiper with an abrasive portion.

16. A wiper cleaner consisting of:
a cleaning surface, said cleaning surface being configured to engage a wiper, said wiper being operable to move, said wiper comprising a windshield wiper blade, said wiper cleaner being operable to remain stationary, said cleaning surface comprising an abrasive portion, said abrasive portion being configured to remove at least one residue from said wiper, said abrasive portion comprising at least one rubber bristle, said abrasive portion further comprising at least one ridge; and
a mounting surface, said mounting surface being configured to join said wiper cleaner with a wiper surface, said mounting surface further being configured to secure said wiper cleaner to a predetermined and stationary position, said mounting surface comprising an adhesive portion, said adhesive portion being configured to secure said wiper cleaner to said wiper surface.
